(19) United States
(12) Patent Application Publication
(10) Pub. No.: US 2009/0327504 A1
(43) Pub. Date: Dec. 31, 2009

(54) WIRELESS DEVICE, AND CONTROL METHOD FOR WIRELESS DEVICE

(75) Inventor: Nobuaki TAKASU, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/495,255

(22) Filed: Jun. 30, 2009

(30) Foreign Application Priority Data
Jun. 30, 2008 (JP) 2008-171600

(51) Int. Cl. G06F 15/173

(52) U.S. Cl. 709/229

(57) ABSTRACT

According to one embodiment, a wireless device includes a communication circuit configured to perform communication with a hosts, an acquisition module configured to perform mutually authentication with the hosts by performing communication therewith to acquire each item of host information which being unique to each of the mutually authenticated hosts, storage device configured to stored host information corresponding to each of the mutually authenticated hosts and connection priority information associate with the corresponding-each item of the host information, a control module configured to determine whether or not connection requests to hosts corresponding to received beacons from the communication circuit in response to connection priority information stored in the storage device when the communication circuit has received the beacon from the hosts.

### CROSS-REFERENCE TO RELATED APPLICATIONS

This application is based upon and claims the benefit of priority from Japanese Patent Application No. 2008-171600, filed Jun. 30, 2008, the entire contents of which are incorporated herein by reference.

### BACKGROUND

1. Field

One embodiment of the invention relates to a wireless device which effects data communication with a host in accordance with a communication standard such as the Wireless Universal Serial Bus (USB) standard, and a control method for the wireless device.

2. Description of the Related Art

The specification of the wireless USB is configured to make a demand for connection from a USB device. This specification poses the same operation as that of insertion of a cable into the USB device in a wired USB. When the wireless USB associates with a plurality of hosts, the operation differs from the wired USB, and a user does not manually perform an operation to connect its device to a target host. Therefore, it becomes a problem that how the user can connect the device to the desired host.

In the wireless USB system, the wireless USB device owns a host list of a plurality of wireless USB hosts, and specifies hosts in order of the list, in priority order or arbitrarily to establish connection (refer to Jpn. Pat. Appln. KOKAI Publication No. 2007-251851).

In the technique which has been described in the patent document given above, the wireless USB device makes a list only for the hosts which can be detected through beacons at that time, adds priority information and then controls connection priority of the shared devices.

However, in the technique, since the wireless USB device makes the list only for the detected hosts, there is the problem that the technique cannot set priority for the hosts which have not actually operated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram depicting a wireless communication system including a host and a wireless USB (WUSB) projector regarding one embodiment of the invention;

FIG. 2 is an exemplary block diagram depicting a system configuration of a personal computer shown in FIG. 1;

FIG. 3 is an exemplary block diagram depicting a system configuration of a WUSB projector shown in FIG. 2; and

FIG. 4 is an exemplary flowchart depicting a procedure of communication control processing of the WUSB projector shown in FIG. 2.

### DETAILED DESCRIPTION

Various embodiments according to the invention will be described hereinafter with reference to the accompanying drawings. In general, according to one embodiment of the invention, a wireless device, comprises a communication circuit configured to perform communication with a plurality of hosts, an acquisition module configured to perform mutually authentication with the plurality of hosts by performing communication therewith to acquire each item of host information which being unique to each of the mutually authenticated hosts, a first storage module configured to store each item of the host information corresponding to each of the mutually authenticated hosts, a detection module configured to detect each item of connection priority information which being set to each item of the host information stored in the storage device, a second storage module configured to associate the detected each item of the connection priority information with corresponding-each item of the host information to store the priority information in the storage device, and a control module configured to determine whether or not connection requests to hosts corresponding to received beacons from the communication circuit in response to connection destination information stored in the storage device when the communication circuit has received the beacon from the hosts.

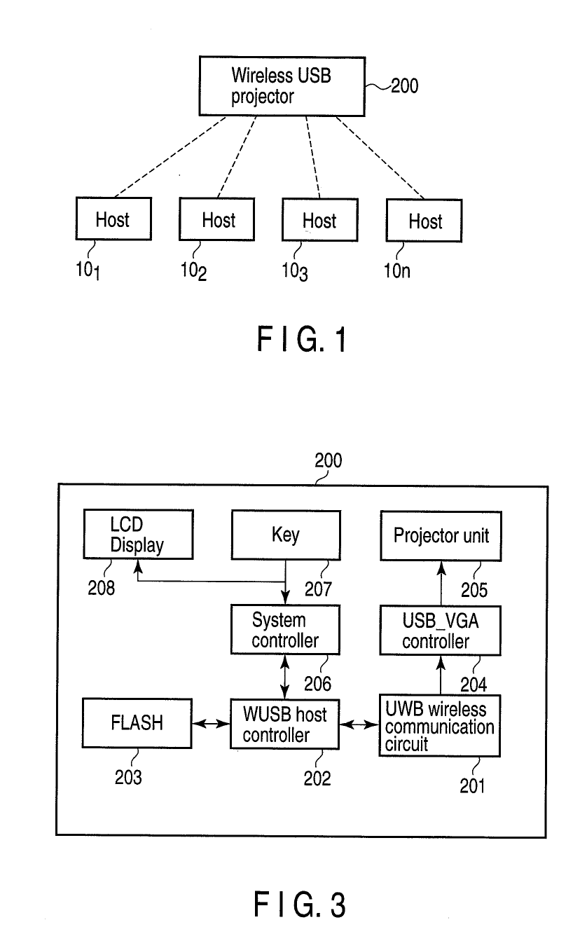

FIG. 1 shows a block diagram depicting information processing devices and a wireless USB (WUSB) projector regarding one embodiment of the invention. As shown in FIG. 1, a plurality of hosts (personal computers) 10₁-10ₙ and a WUSB projector device 200 include each controller which is compliant with WUSB standards. One set of the information processing devices selected from among the plurality of information processing devices becomes a host and the WUSB projector 200 becomes a device. A video signal is transmitted from the information processing device to the WUSB projector 200.

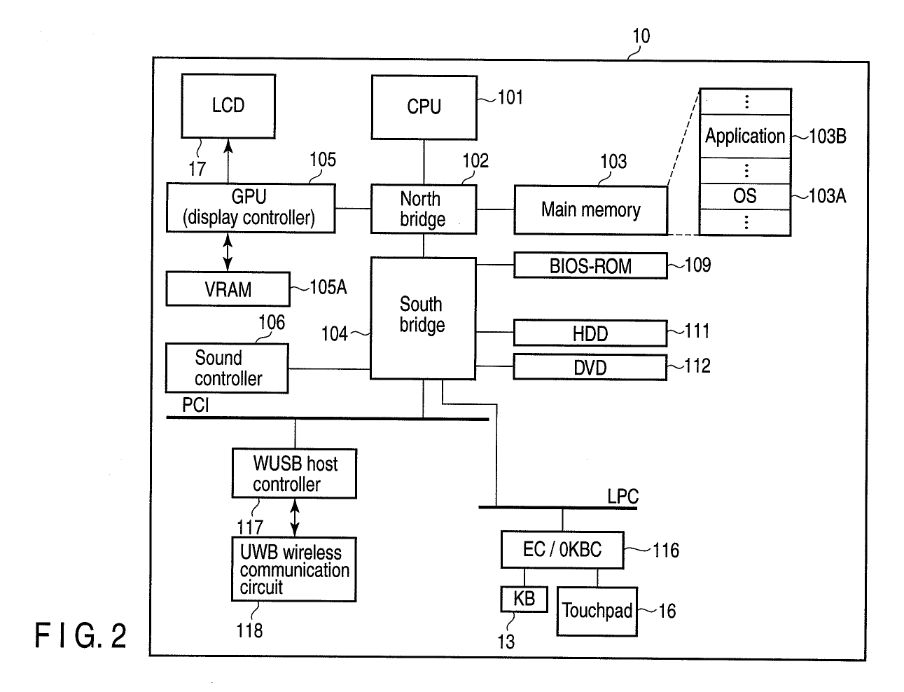

Referring to FIG. 2, one example of a system configuration of the hosts 10₁-10ₙ will be described.

Each host (10₁-10ₙ) includes, as shown in FIG. 2, a CPU 101, a north bridge 102, a main memory 103, a south bridge 104, a graphics processing unit (GPU) (i.e., display controller) 105, a video memory (VRAM) 105A, a sound controller 106, a basic input output system (BIOS)-ROM 109, a hard disk drive (HDD) 111, a DVD drive 112, an embedded controller/keyboard controller (EC/KBC) 116, a WUSB host controller 117, and a ultra wideband (UWB) wireless circuit 118.

The CPU 101 is a processor which controls operations of the host 10, executes an operating system (OS) 103A and various application programs such as a priority setting utility software 103B which have been loaded from the HDD 111 into the main memory 103. The CPU 101 also executes a BIOS stored in the BIOS-ROM 109. The BIOS is a program for controlling hardware.

The north bridge 102 is a bridge device which connects between a local bus of the CPU 101 and the south bridge 104. The north bridge 102 builds in a memory controller which controls access of the main memory 103. The north bridge 102 has a function of communicating with the GPU via a serial bus of PCI EXPRESS standards.

The GPU 105 is a display controller which controls an LCD 17 to be used as a display monitor of the host 10. A display signal to be generated from the GPU 105 is transmitted to the LCD 17.

The south bridge 104 controls each device on a low pin count (LPC) bus and each device on a peripheral component interconnect (PCI) bus. The south bridge 104 builds in integrated drive electronics (IDE) controller which controls the HDD 111 and the DVD drive 112. Further, the south bridge 104 has a function of communication with the sound controller 106.

The sound controller 106 is a sound source device, and outputs audio data to be reproduced to loud-speakers 18A, 18B or High-Definition Multimedia Interface (HDMI) control circuit 3.

The EC/KBC 116 is a one chip micro computer with an EC/KBC for controlling power management and a keyboard (KB) controller for controlling a KB 13 and a touchpad 16 integrated therein.

The WUSB host controller 117 controls communication with a device performed by the UWB wireless communication circuit 118.

A system configuration of the WUSB projector device 200 will be described by referring to FIG. 3.

As shown in FIG. 3, the WUSB projector device 200 includes a UWB wireless communication circuit 201, a WUSB controller 202, a flash memory 203, a USB_VGA controller 204, a projector unit 205, a system controller 206, a Key 207, and an LCD display 208.

The UWB wireless communication circuit 201 is a communication circuit which communicates with the UWB wireless communication circuit 118 on a host side in a UWB system. The WUSB controller 202 controls the UWB wireless communication circuit 201. Connection priority information corresponding to the hosts which have been authenticated with each other (described below) is stored in the flash memory 203.

The USB_VGA controller 204 generates video data by which the projector unit 205 projects a video according to the video signal which has been received by the UWB wireless communication circuit 201.

The system controller 206 receives a signal corresponding to the Key 207 operated by a user to perform processing corresponding to the signal. The system controller 206 displays a display corresponding to the signal on the LCD display 208. The system controller 206 also reports an input signal from the Key 207 to the WUSB controller 202.

The WUSB controller 202 of the WUSB projector 200 performs initial authentication such as cable connection with the hosts then records information required for connection such as connection device ID (CHIDS) and secret keys which are unique to the hosts to be connected in the flash memory 203. At this moment, the hosts also record connection information such as a connection device ID (CDID) and a secret key of a device to be connected in a storage device.

Thereby, when completing the initial authentication and connecting through the wireless WUSB, the authentication key, etc., included in the connection information is mutually exchanged and confirmed then communication is enabled.

The projector device 200 adds the connection priority information to the connection information. The WUSB controller 202 of the projector device 200 confirms whether the connection priority information has been set for searching the hosts which are connectable to the device 200, and when the information has been set, the WUSB controller 202 searches the hosts one by one in accordance with the setting of the connection priority setting to connect the hosts to the device 200. The connection priority information includes, for example, information thus: priority “0”: no priority set; priority “1”: first priority; priority “2”: second priority, . . . .

Thus, the device 200 for shared use in a plurality of hosts can be set priority for each host, even in a place where a plurality of hosts are present, specified hosts can be connected to the device 200 in turn. The setting of the priority is performed by using the Key 207, and the set priority may be confirmed by displaying the priority on the LCD display 208.

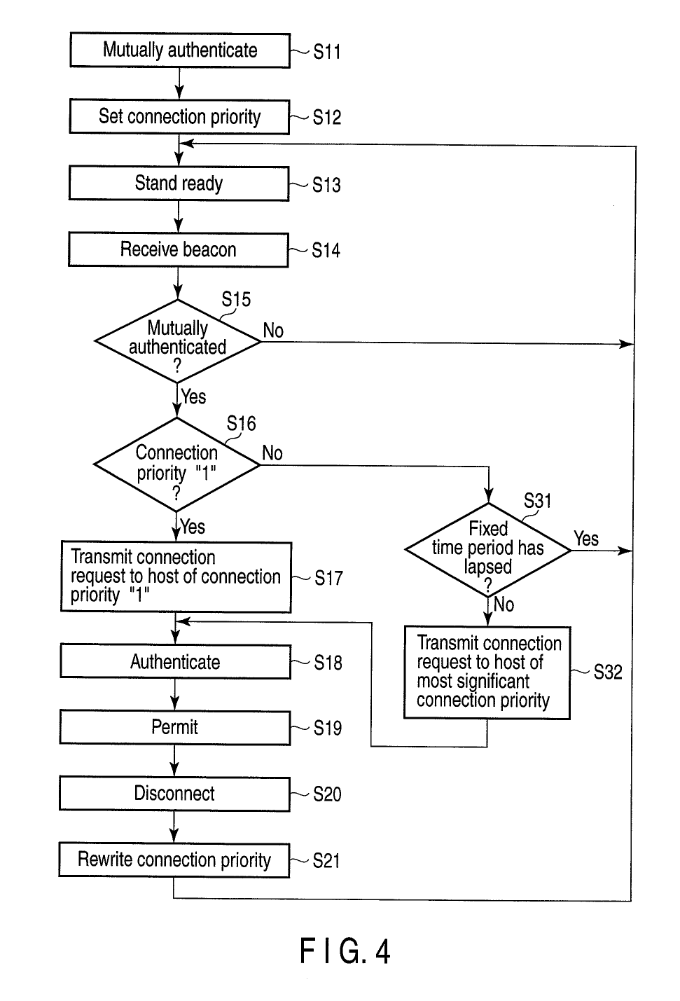

A flowchart of FIG. 4 will describe the connection processing according to the priority.

The WUSB controller 202 performs mutual authentication (association) with a plurality of hosts 10₁-10ₙ (Block S11). The association is a method for mutually recognizing the wireless communication devices when firstly connecting the communication devices. That is, the association is a procedure which enables the communication devices to connect with only already known partners, enables the communication devices to connect with only reliable partners, and exchanges the secret keys in its process of the procedure. The WUSB controller 202 stores the data which has been exchanged to and from the hosts in the storage device.

The data to be exchanged to and from the hosts includes a CHID which is unique to each host, a CDID which is unique to the device 200, and a Connection Key. The Connection Key is a unique value generated from the wireless USB host, and the Connection Key generated from the CHID and the CDID become the secret key.

The system controller 206 detects the connection priority for the hosts 10₁-10ₙ which has been input by the user using the Key 207 (Block S12). For instance, it is assumed that priority “1” is set for the host 101 is set as, priority “2” is set for a personal computer 102, and priority “3” is set for a personal computer 103. The system controller 206 reports the detection result to the WUSB controller 202. The WUSB controller 202 stores the connection priority set to each host in the flash memory 203.

The setting of the connection priority is performed for the hosts of which the connection information is stored in the flash memory 203. Even if the hosts which are not active, as long as mutual authentication has been already performed and the connection information has been stored in the flash memory 203, it is possible for such hosts to be set the connection priority.

The setting of the connection priority is not limited to be performed from the side of the device 200. It is also possible to set the connection priority in the host connection information stored in the device through the communication with the device 200 by using the priority setting utility software 103B from the hosts during connection. For instance, the software 103B obtains the CHIDs of the hosts which have been stored in the flash memory 203 and already authenticated. The software 103B displays a list of the CHIDs on display devices of the hosts, and then, the user sets the connection priority. The software 103B transmits the set connection priority to the device 200. The WUSB controller 202 detects the transmitted connection priority to store it in the flash memory 203.

After setting the connection priority, the WUSB controller 202 stands ready to receive a beacon to be transmitted from the hosts (Block S13). The hosts periodically transmit the beacons including the information of their own CHIDs. When receiving the beacon, the UWB wireless communication circuit 201 transfers the received data to the WUSB controller 202 (Block S14).

The WUSB controller 202 extracts the CHID from the transferred data. The WUSB controller 202 determines whether or not the device 200 has been mutually authenticated with the host having the extracted CHID by referring to the data stored in the flash memory 203 (Block S15). If it is determined that the host has not mutually authenticated with the device 200 (No, Block S15), the WUSB controller 202 stands ready to receive a beacon from another host (Block S13).

If it is determined the host has been authenticated with the device 200 (Yes, Block S15), the WUSB controller 202 determines whether or not the priority of the host is set as priority “1” (Block S16). If it is determined that the priority is not set as priority “1” (No, Block S16), the WUSB controller 202 determines whether or not a fixed time period has lapsed from the first stand-by processing (Block S31). If determining the elapse of the fixed time period (Yes, Block S31), the WUSB controller 202 returns to the stand-by processing of Block S13.

If it is determined that the priority is set as priority “1” (Yes, Block S16), the WUSB controller 202 uses the UWB wireless communication circuit 201 to transmit the connection request to the host (Block S17).

In Block S31, if it is determined that the fixed time period has not lapsed (No, Block S31), the WUSB controller 202 uses the UWB wireless communication circuit 201 to transmits the connection request for the host having the most significant connection priority from among the hosts which have received the beacons (Block S32).

The WUSB controller 202 performs authentication processing which establishes the mutual reliability among the hosts and the device to and from the hosts which have transmitted the connection requests (step S18) and permission processing which permits the exchange of the information through secure communication (Block S19), and communication is established.

After this, when the connection is cut (Block S20), the WUSB controller 202 rewrites the connection priority information stored in the flash memory 203 (Block S21). If the communication is made with the host having the connection priority information of the priority “1”, the WUSB controller 202 varies the connection priority information to the last priority. Then, the connection priority information of each host is carried one by one. In Block S32, after transmitting the connection request to the host having the most significant connection priority (e.g., priority “a”), the WUSB controller 202 sets the connection priority of the connected host as the least significant rank, and successively carries the connection priority of the hosts having connection priority “a+1” or lower.

The WUSB controller 202 then returns to the stand-by processing (Block 13) in order to receive the beacons from the hosts.

According to the processing given above, the WUSB projector 200 can communicate with the hosts in order from the host having the most significant connection priority information.

As regards a method for setting connection priority, a device itself may have a display device such as the LCD display 208 and an input device such as the Key 207, display the CHIDs of the registered hosts as a list, and operate to set the connection priority by means of the input device such as the key 207 on the screen of the display 208. Thus, even if there is no host, the connection priority can be set solely the device and anybody can set the connection priority.

Varying setting connection priority information to be added to the host connection information stored in the device enables setting so that the connectable host is limited to one and a specific host cannot be connected.

For instance, the host connection priority information may be set as follows: 00h: priority “0”; 01h: priority “1”; 02h: priority “2”; F0h: this host alone is connectable; F1h: this host is not permitted to be connected. Thus, the connection right and connection priority of the hosts may be varied, and the use state of the device may be controlled in accordance with the situation of the connection of the hosts.

Providing a timer for the WUSB controller 202 in the device, or for the system controller 206 in the device, and including a function of automatically clearing the set connection priority information after the elapse of a fixed time after the completion of setting therein make it possible to prevent inconvenience such as monopoly on the device or such that nobody can connect between the hosts and the device due to wrong setting from occurring.

Registering the names of the hosts from the utility software 103B at the time of the initial authentication to store them as the host connection information of the device enables easily specifying the hosts to be set by enabling not the CHIDs but the names of the hosts to display.

Unless the device becomes successful in authentication processing by means of inputting a password, it is preferable not to allow management such as deletion and change in setting of the connection information with hosts which have already authenticated with the device. The connection priority of the hosts can be changed solely by a specific person such as a manager who knows the passwords by setting the connection priority via a management function and management software by means of authentication information management software capable of deleting and changing the connection information through the access and input the password to the management function during connection of the hosts to the device,

While the projector has been described as the example of the device, another device can be used. For instance, a printer or a scanner can be used.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless device, comprising:
a communication module configured to communicate with a plurality of hosts;
an acquisition module configured to mutually authenticate connections between the wireless device and the plurality of hosts by communicating with the plurality of hosts and to acquire items of host information corresponding to the mutually authenticated hosts;
a first storage module configured to store the items of the host information corresponding to the mutually authenticated hosts;
a detection module configured to detect items of connection priority information set to items of the host information stored in the storage device respectively;
a second storage module configured to associate the detected items of the connection priority information with corresponding items of the host information and to store the connection priority information in the storage device; and
a controller configured to determine whether to send a connection request to hosts corresponding to beacons received from the communication module in response to the connection priority information stored in the storage device when the communication module has received the beacons from the hosts.

2. The wireless device of claim 1, wherein
the controller is configured to transmit the connection request to the host of the most significant connection priority information among the hosts which have received the beacons,
the controller is configured to set the connection priority information of a host of the most significant connection priority information as the least significant rank, and to successively carry the connection priority information corresponding to the items of the host information of which the connection priority information is not higher than the connection priority information of the disconnected host when a connection to the host of the most significant connection priority information is disconnected after establishing the connection to the host which has transmitted the connection request.

3. The wireless device of claim 1, wherein
the controller is configured to control whether the communication module is to transmit the connection request to a given host.

4. The wireless device of claim 1, wherein
the controller is configured to delete the connection priority information stored in the storage device when a fixed time period has lapsed after the connection priority information was stored in the storage device.

5. The wireless device of claim 1, wherein
the communication is based on wireless universal serial bus (USB) standards.

6. A control method for a wireless device, comprising:
mutually authenticating of connections between a plurality of hosts and the wireless device by communication with the plurality of hosts and acquiring items of host information corresponding to the mutually authenticated hosts;
storing the items of the host information corresponding to the mutually authenticated hosts in a storage device;
detecting items of connection priority information which has been set to the items of the host information stored in the storage device;
associating items of the detected connection priority information with corresponding items of the host information to store the connection priority information in the storage device;
receiving beacons comprising the host information from the hosts; and
determining whether a connection request should be transmitted to a host corresponding to the received beacons with reference to connection priority information stored in the storage device.

7. The control method of claim 6, wherein the determining comprises:
determining whether to transmit the connection request to a host of the most significant connection priority information among the hosts which have received the beacons; and
setting the connection priority information of the host of the most significant connection priority information as the least significant rank, and successively carrying the connection priority information corresponding to the items of the host information of which the connection priority information is not higher than the connection priority information of the disconnected host when connection to the host of the most significant connection priority information has been disconnected after establishing the connection to the host which has transmitted the connection request.

8. The control method of claim 6, wherein
the determining comprises determining whether to transmit the connection request to a given host.

9. The control method of claim 6, wherein
the determining comprises deleting the connection priority information stored in the storage device when a fixed time period has lapsed after the connection priority information was stored in the storage device.

10. The control method of claim 6, wherein
the communication is based on wireless USB standards.
